(19) United States
(12) Patent Application Publication
(10) Pub. No.: US 2012/0262735 A1
(43) Pub. Date: Oct. 18, 2012

(54) METHOD AND APPARATUS FOR GAMING PROMOTIONAL PRINTER

(75) Inventor: Mark Meyerhofer, La Canada, CA (US)

(73) Assignee: FUTURELOGIC, INC., Glendale, CA (US)

(21) Appl. No.: 13/253,081

(22) Filed: Oct. 5, 2011

Related U.S. Application Data
(63) Continuation-in-part of application No. 12/892,626, filed on Sep. 28, 2010, now Pat. No. 8,253,970.
Application No. 12/892,626 is a continuation of application No. 10/952,299, filed on Sep. 27, 2004, now Pat. No. 7,812,992.
Application No. 10/952,299 is a continuation-in-part of application No. 10/405,112, filed on Mar. 31, 2003, now Pat. No. 7,594,855.
Application No. 10/405,112 is a continuation-in-part of application No. 12/710,348, filed on Feb. 22, 2010, now Pat. No. 8,144,356.
Application No. 12/710,348 is a continuation of application No. 10/434,307, filed on May 7, 2003, now abandoned.
(60) Provisional application No. 60/369,097, filed on Mar. 29, 2002.
(60) Provisional application No. 60/378,491, filed on May 7, 2002.

(51) Int. Cl. G06K 15/02

(52) U.S. Cl. 358/1.6

(57) ABSTRACT

A method and apparatus for a promotional module for use within a cashless enabled gaming machine or vending machine are disclosed. A promotional module includes a coupon database describing a stack of coupons that are specified using a template based couponing printer language. A coupon is selected for creation and issued to a user or player or user based on a matrix of event-based triggers involving factors or parameters known to the promotional module directly or supplied by a master promotional controller. Triggers may include the time of day, the date or amount of a cash out voucher to be issued to the user or player, the duration of play on a gaming machine, a player classification, the amount of money or credits added to a game, or a random frequency of coupon issuance having satisfied any or all of the aforementioned factors.

### CROSS-REFERENCE TO RELATED APPLICATIONS

This application is a continuation-in-part of U.S. application Ser. No. 12/892,626, filed Sep. 28, 2010, which is a continuation of U.S. application Ser. No. 10/952,299, filed Sep. 27, 2004 which is a continuation-in-part of U.S. application Ser. No. 10/405,112 filed Mar. 31, 2003 which claims the benefit of U.S. Provisional Patent Application No. 60/369,097, filed Mar. 29, 2002, the contents of each of which are hereby incorporated by reference as if fully stated herein, and this application is also a continuation-in-part of U.S. application Ser. No. 12/710,348, filed Feb. 22, 2010 which is a continuation of U.S. application Ser. No. 10/434,307 filed May 7, 2003 which claims the benefit of U.S. Provisional Patent Application No. 60/378,491, filed May 7, 2002, the contents of each of which are hereby incorporated by reference as if fully stated herein.

### BACKGROUND

1. Field of the Invention

This invention relates generally to gaming and vending printers and more specifically to gaming and vending printers performing promotional coupon printing.

2. Description of the Related Art

The gaming machine manufacturing industry provides a variety of gaming machines for the amusement of gambling players. An exemplary gaming machine is a slot machine. A slot machine is an electronic video or electro-mechanical game wherein chance or the skill of a player determines the outcome of the game. Slot machines are usually found in casinos or other more informal gaming establishments.

Gaming machine manufacturers have more recently introduced cashless enabled gaming machines to the market and these have begun to find wide acceptance in the gaming industry. Cashless enabled gaming machines are so named because they can conduct financial exchanges using a mixture of traditional currencies and vouchers. Typically, a cashless enabled gaming machine has a gaming printer to produce vouchers and a bill validator that supports automatic reading of vouchers. To coordinate the activities of multiple cashless enabled gaming machines, one or more cashless enabled gaming machines may be electronically coupled to a cashless enabled gaming machine system that controls the cashless operations of a cashless enabled gaming machine.

When a player cashes out using a cashless enabled gaming machine coupled to a cashless enabled gaming machine system, the cashless enabled gaming machine signals the system and the system may determine the type of pay out presented to the player. Depending on the size of the pay out, the cashless enabled gaming machine system may cause the cashless enabled gaming machine to present coins in the traditional method of a slot machine, or the cashless enabled gaming machine system may cause a gaming printer in the cashless enabled gaming machine to produce a voucher for the value of the pay out. The voucher may then be redeemed in a variety of ways. For example, the voucher may be redeemed for cash at a cashier's cage or used with another cashless enabled gaming machine. In order to use the voucher in a cashless enabled gaming machine, the voucher is inserted into a bill validator or acceptor of another cashless enabled gaming machine at a participating casino and the cashless enabled gaming machine system recognizes the voucher, redeems the voucher, and places an appropriate amount of playing credits on the cashless enabled gaming machine.

Cashless enabled gaming machines have found an increasing acceptance and use in the gaming industry with players who enjoy the speed of play and ease of transporting their winnings around the casino and the casinos who have realized significant labor savings in the form of reduced coin hopper reloads in the games, and an increase in revenue because of the speed of play. This increasing acceptance practically guarantees a wide installed base of networked games with captive player audiences for issuance of coupons and promotional tickets using generally the same equipment already installed within a cashless enabled gaming machine system for the purpose of supporting cashless gaming vouchers. In addition, vending machine manufacturers have increasingly added additional printing features to their vending machines.

### SUMMARY OF THE INVENTION

In one aspect of the invention, a promotional module for use within a cashless enabled gaming machine or vending machine controls printing of vouchers and coupons. The promotional module includes a coupon database describing a stack of coupons that are specified using a template based couponing printer language. A coupon is selected for creation and issued to a user or player based on a matrix of play metric event-based triggers involving factors or parameters known to the promotional module directly or supplied by a master promotional controller. Triggers may include the time of day, the date or amount of a cash-out voucher to be issued to the user or, player, the duration of play on a gaming machine, a player classification, the amount of money or credits added to a game, or a random frequency of coupon issuance having satisfied any or all of the aforementioned factors. The promotional module may further include the ability to store all of the coupons, trigger conditions, and related information resident in the promotional module in a non-volatile fashion thus enabling a host system to download a promotional environment into the promotional module which will run promotional campaigns on behalf of the hosting system.

In one aspect, a method of printing a promotional coupon in a gaming environment includes receiving coupon data by a promotional module in a cashless enabled game from a promotional controller via a communications network. The coupon data includes a coupon description written in a template definition language. The promotional module then generates the coupon using variable data and the coupon template in response to a trigger.

In another aspect of the invention, the variable data is received by the promotional module from the master promotional controller via a communications network. In this aspect, the master promotional controller generates the trigger and transmits the trigger to the promotional module via the communications network.

In another aspect of the invention, the coupon data includes trigger control parameters and the trigger is generated by the promotional module using the trigger control parameters and trigger data. The trigger data is associated with vending or play metrics and may include a date, a time of day, a frequency of issuance of the coupon, or a time of play by a player of a gaming machine.

In another aspect of the invention, the promotional module is further coupled to a gaming or vending machine controller and the trigger data is received by the promotional module from the machine controller. The trigger data may include a player identifier, an amount of money in play on a gaming machine, a duration of a current session of play of a gaming machine, a cash-in of a player or a cash-out of a player.

In another aspect of the invention, coupon issuance data is stored by the promotional module and the coupon issuance data is transmitted by the promotional module to the master promotional controller via the communications network.

In another aspect of the invention, a master promotional controller transmits coupon data to a promotional module via a communications network with the coupon data including a coupon template. The master promotional controller transmits variable data and trigger data to the promotional module via the communications network. In response to the transmission, the promotional module generates a coupon using the coupon template and the variable data.

In another aspect of the invention, the promotional module stores coupon issuance data and the master promotional controller receives the coupon issuance data by the master promotional controller from the promotional module via the communications network.

In another aspect of the invention, a promotional module comprises a processor and a memory coupled to the processor. The memory has stored program instructions executable by the processor where the program instructions include receiving coupon data including a coupon template from a master promotional controller via a communications network. The program instructions for the promotional module also include instructions for generating a coupon using variable data and the coupon template in response to a trigger.

In another aspect of the invention, a master promotional controller includes a processor and a memory coupled to the processor. Program instructions for implementing the features of a master promotional controller are stored in the memory and are executable by the processor. The program instructions include: transmitting coupon data to a promotional module via a communications network wherein the coupon data includes a coupon template, transmitting variable data to the promotional module via the communications network, and transmitting trigger data to the promotional module whereby the promotional module generates a coupon using the coupon template and the variable data in response to the trigger data.

### BRIEF DESCRIPTION OF THE DRAWINGS

These and other features, aspects, and advantages of the present invention will become better understood with regard to the following description, appended claims, and accompanying drawings where:

FIG. 1 is a block diagram illustrating a gaming or vending environment employing couponing in accordance with an exemplary embodiment;

FIG. 2a is a deployment diagram of a coupon issuing system in accordance with an exemplary embodiment;

FIG. 2b is a deployment diagram illustrating an aspect of using promotional module in conjunction with a Slot Machine Interface Board (SMIB) in accordance with an exemplary embodiment;

FIG. 2c is a deployment diagram illustrating another aspect of using promotional module in conjunction with a Slot Machine Interface Board (SMIB) in accordance with an exemplary embodiment;

FIG. 2d is a deployment diagram illustrating another aspect of an exemplary promotional module coupled to a printer and a master promotional controller in accordance with an exemplary embodiment;

FIG. 2e is a deployment diagram illustrating another aspect of an exemplary promotional module coupled to a gaming or vending machine controller, a master promotional controller and a printer in accordance with an exemplary embodiment;

FIG. 3 is an illustration of a coupon including logical fields described in a template based printer language in accordance with an exemplary embodiment;

FIG. 4 is a block diagram of coupon template field elements stored partially resident in a promotional gaming printer and partially supplied by a master promotional controller at the time of print and issue in accordance with an exemplary embodiment;

FIG. 5 is a block diagram of an exemplary coupon “stack” and logical trigger matrix resident in a promotional printer in accordance with an exemplary embodiment;

FIG. 6 is a process flow diagram of a coupon generation process in accordance with an exemplary embodiment;

FIG. 7 is a sequence diagram of a coupon generation process in accordance with an exemplary embodiment;

FIG. 8a is an architecture diagram of a promotional printer in accordance with an exemplary embodiment;

FIG. 8b is an architecture diagram of a promotional module in accordance with an exemplary embodiment;

FIG. 9 is an architecture diagram of a master promotional controller in accordance with an exemplary embodiment;

FIG. 10a is a block diagram of a gaming or vending machine incorporating a multidrop communications network in accordance with an exemplary embodiment;

FIG. 10b is a block diagram a gaming or vending machine incorporating a point-to-point communications system in accordance with an exemplary embodiment;

FIG. 11 is a sequence diagram of a process of a promotional module using passive listening to generate coupon triggers in accordance with an exemplary embodiment;

FIG. 12a is a sequence diagram of a process of couponing and vouchering operations in a system having a promotional module coupled to a printer, a gaming or vending machine controller and a master promotional controller in accordance with an exemplary embodiment;

FIG. 12b is a sequence diagram of another process of couponing and vouchering operations in a system having a promotional module coupled to a printer, a gaming or vending machine controller and a master promotional controller in accordance with an exemplary embodiment;

FIG. 13 is a sequence diagram of a process of couponing and vouchering operations in a system having a promotional module coupled to a printer, a gaming machine controller, and a master promotional controller in accordance with an exemplary embodiment;

FIG. 14 is a sequence diagram of another process of couponing and vouchering operations in a system having a promotional module coupled to Slot Machine Interface Board (SMIB) a gaming machine printer, a gaming machine controller and a master promotional controller in accordance with an exemplary embodiment; and

FIG. 15 is a sequence diagram of another process of couponing and vouchering operations in a system having a promotional module coupled to Slot Machine Interface Board (SMIB), a printer, a gaming or vending machine controller and a master promotional controller in accordance with an exemplary embodiment.

### DETAILED DESCRIPTION

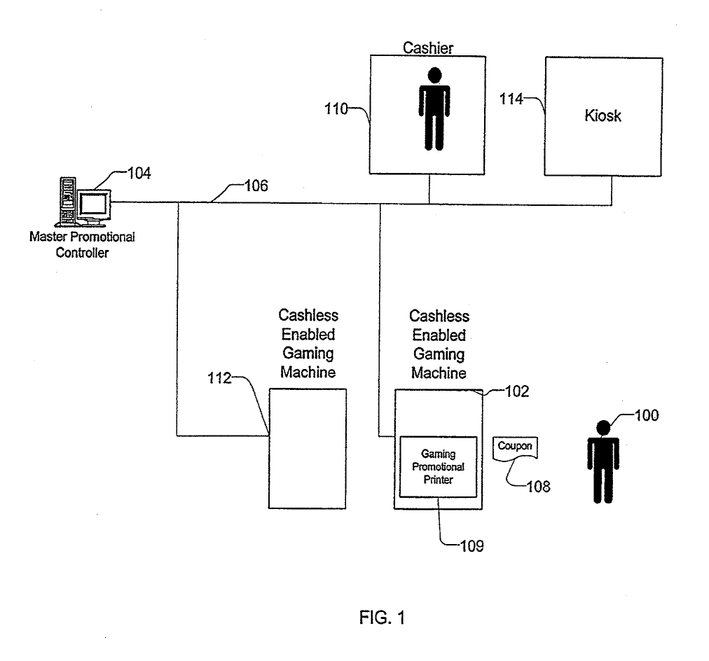

FIG. 1 is a block diagram illustrating a vending or gaming environment employing couponing in accordance with an exemplary embodiment of the present invention. A player 100 uses a cashless enabled gaming machine 102 to play a gambling game or game of skill. As the player plays the game, a master promotional controller 104 coupled to one or more cashless enabled gaming machines through a communications network 106 triggers the generation of promotional coupons 108 for use by the player. The promotional coupons are generated by a promotional printer 109 included in a cashless enabled gaming machine. The master promotional controller can either be a controller on a network coupled to one or more promotional printers, a controller within a cashless enabled gaming machine or promotional printer, or an intelligent routing and management device for one or more promotional printers. In one embodiment of a master promotional controller, the master promotional controller directs the promotional activity of the promotional printers via direct promotional coupon requests. In another embodiment of a master promotional controller, the master promotional controller uses a cashless enabled gaming machine's promotional printer to store promotional coupon databases and triggers.

Once a promotional coupon has been issued by a promotional printer, the promotional coupon may be redeemed with a human operator or cashier 110, or redeemed automatically through a another redemption device, such as a bill validator or acceptor in another cashless enabled gaming machine 112, or redeemed at a kiosk 114 which is not a game but provides some other form of automatic interface for a promotional coupon holder.

In one embodiment of a master promotional controller, the master promotional controller is coupled to the redemption devices. In another embodiment of a master promotional controller, a non-game kiosk or casino personnel may or may not interface back to the master promotional controller when redeeming a promotional coupon. Information relative to couponing activity is exchanged with the master promotional controller, the net result being the promotional printers fitting into the system as distributed intelligent sub units, significantly off loading the master promotional controller's real time servicing requirements and avoiding network bandwidth issues associated with live streaming of promotional coupons during a relatively short cash-out time window.

In one gaming environment employing couponing in accordance with an exemplary embodiment of the present invention, each promotional printer in the gaming environment has a unique address or identifier so that a population of promotional printers on the network can be addressed in whole or individually for promotional purposes.

In one aspect, a stand alone promotional printer includes all of the necessary processing capabilities, memory, and promotional printer programming instructions 209 needed to perform promotional couponing operations for the cashless enabled gaming machine or vending machine. In other embodiments of promotional printers, a promotional printer is created by coupling a promotional module 210 to a conventional vending or gaming printer, enabling the vending or gaming printer to function as a promotional printer. A standalone gaming or vending promotional printer or a promotional printer created from a vending or gaming printer coupled to a promotional module are termed herein as either a “promotional printer” or a “promotional module.”

In another aspect, a promotional printer or a promotional module accepts promotional database loads and transfers statistical data with the master promotional controller either through a main communication port or interface used for normally signaling pay out vouchers in a gaming machine or receipts for a vending machine, or through an auxiliary port or interface, thus allowing the promotional printer's promotional activities to be conducted in series or in parallel with the promotional printer's cash-out voucher or receipt printing functions within the gaming machine or vending machine.

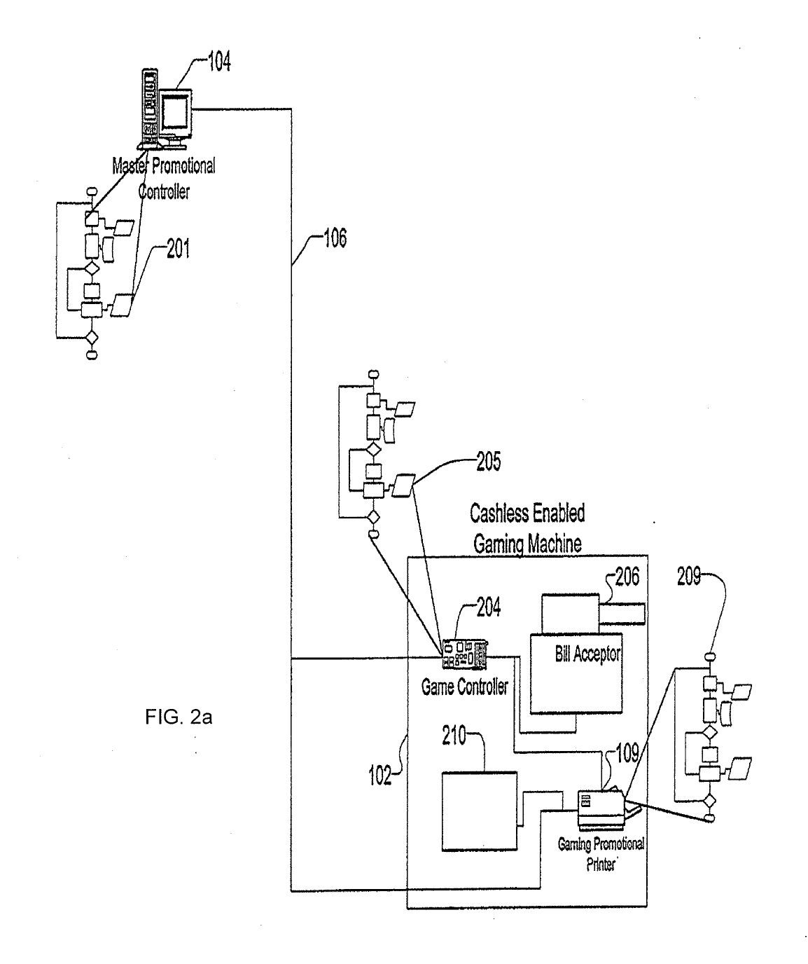

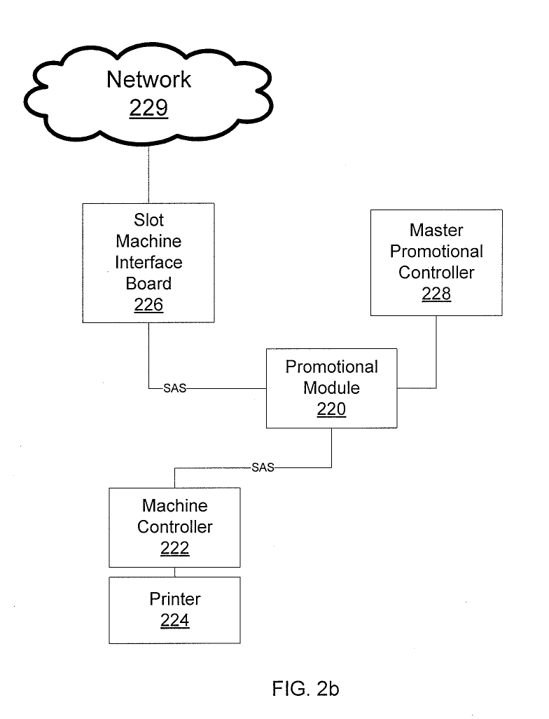

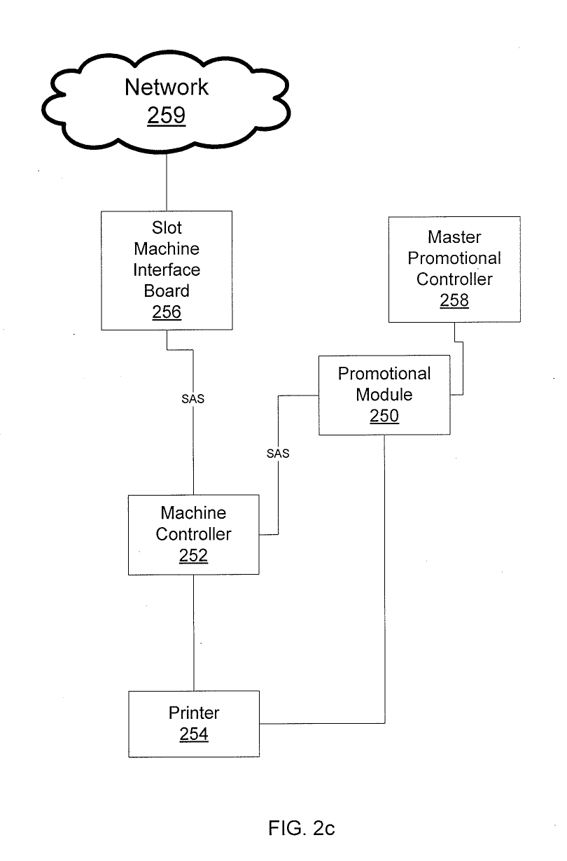

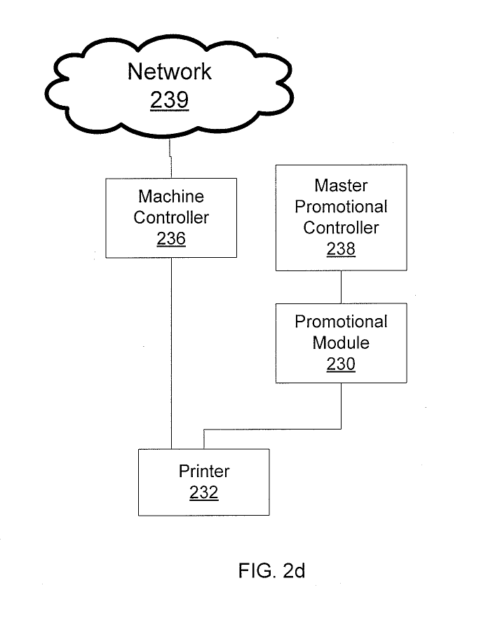

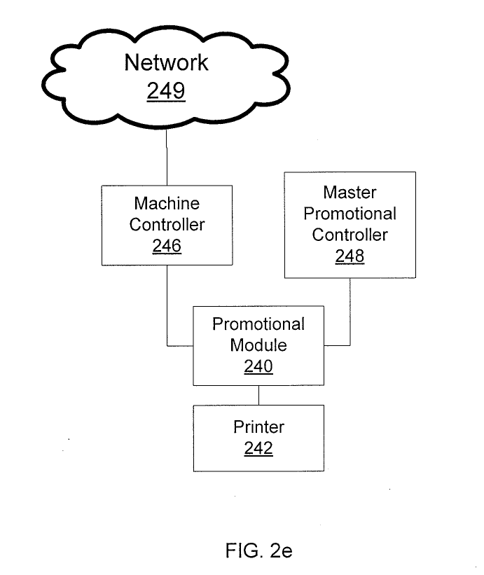

FIG. 2a is a deployment diagram of a couponing system in accordance with an exemplary embodiment of the present invention. In a couponing system, a master promotional controller 104 is coupled to one or more cashless enabled gaming or vending machines, as illustrated by cashless enabled gaming machine 102, through a communications network 106 by coupling to a promotional printer 109 included in the cashless enabled gaming machine. The master promotional controller is programmable and includes master promotional controller programming instructions 201 controlling the master promotional controller's operations including communications with the promotional printer.

The master promotional controller may be coupled to a vending or gaming machine controller 204 included in the cashless enabled gaming machine or vending machine. By coupling to a machine controller, the master promotional controller may receive information from the machine controller about the vending or gaming operations of the cashless enabled gaming or vending machine separately from the promotional printer printing operations.

The cashless enabled gaming or vending machine may also include a bill validator or acceptor 206 coupled to the machine controller. A cashless enabled gaming or vending machine uses the bill validator or acceptor for redemption of promotional coupons and acceptance of vouchers or cash.

In operation, the master promotional controller transmits packets of variable data or coupon data describing a promotional database to the promotional printer. The contents of the promotional database include descriptions of a plurality of promotional coupons, cash vouchers, advertisements or other enticements which are hereinafter collectively referred to as “coupons.” The promotional printer receives the promotional database and stores the promotional database in the promotional printer's local memory.

The promotional printer also stores specifications of how to print the coupons in its local memory. The specifications of the coupons are stored as templates written in a template based printer language. This allows the coupons to be predefined, formatted, and stored in the promotional printer completely or partially for later recall.

Up on reception of a trigger data signal from either the master promotional controller or the machine controller, the promotional printer references and parses the promotional database and coupon templates to generate and issue promotional coupons or tickets printed on paper media. The paper media may be used specifically for the purpose of generating promotional coupons, or the paper media may be used for the purpose of printing pay out vouchers associated with cashless gaming.

FIG. 2b is a deployment diagram illustrating an aspect of using a promotional module in conjunction with a Slot Machine Interface Board (SMIB). A promotional module 220 is coupled at a primary interface to a Slot Machine Interface Board (SMIB) 226. The SMIB communicates with the promotional module using a Slot Accounting System (SAS) protocol. A SAS protocol is a high level protocol used within the gaming industry for communications between player tracking systems, gaming machines, peripherals within the gaming machine and essentially any device that may be found in a gaming establishment. However, it should be understood that other communication protocols implemented using protocols, such as Universal Serial Bus (USB), RS-232, NetPlex, etc. can be employed for communications between the SMIB and the promotional module. The promotional module is further coupled to a gaming machine controller 222 and the machine controller is further coupled to a gaming machine printer 224. The promotional module is also coupled to a master promotional controller 228.

The SMIB 226 is further coupled to a network 229 through which the SMIB communicates with other devices and systems in a gaming establishment such as accounting servers, player tracking servers and the like.

In operation, the promotional module 220 receives coupon data from the master promotional controller 228. The promotional module then stores the coupon data for later use as described herein. The machine controller receives cash-in data from a bill validator or acceptor or other device (not shown) and transmits the cash-in data to the promotional module which forwards the cash-in data to the SMIB. The SMIB then forwards the data to an accounting server or the like (not shown) via the network 229. As the machine controller executes a game for a player, the machine controller may or may not send play metrics to the SMIB via the promotional module. When the player cashes-out from the game, the machine controller transmits the cash-out request through the promotional module to the SMIB. The SMIB then retrieves cash-out information including voucher data from an accounting server or the like (not shown). The SMIB forwards the cash-out information to the machine controller through the promotional module. The machine controller then sends the voucher data to the printer 224 for printing a voucher for the player. As the promotional module is the conduit for the cash-in information, voucher information, play metrics, etc., the promotional module can use this information to determine if a coupon should be printed. If the promotional module determines that a coupon should be printed, the promotional module generates coupon data as described herein. The promotional module transmits the generated coupon data to the machine controller which in turn transmits the coupon data to the printer for printing a coupon for presentation to a player.

In one aspect, the promotional module 220 and the master promotional controller 228 may be directly coupled to each other through a wired connection. In another aspect, the promotional module and the master promotional controller are coupled via a network. In yet another aspect, the promotional module and the master promotional controller are coupled via a wireless connection, either directly or indirectly through a network.

FIG. 2c is a deployment diagram illustrating another aspect of using promotional module in conjunction with a Slot Machine Interface Board (SMIB) in accordance with an exemplary embodiment. A promotional module 250 is coupled at a primary interface to a gaming machine controller 252. The promotional module communicates with the machine controller using a SAS protocol as described herein although it should be understood that other protocols may be used. The promotional module is also coupled by a printer interface to a gaming machine printer 254 by an auxiliary communication port or interface of the printer. The promotional module may communicate with the printer using a communication protocol such as Universal Serial Bus (USB), RS-232, NetPlex, etc.; however, it will be understood by those skilled in the art of printer protocols that many such protocols are suitable for such a purpose. The promotional module is further coupled by its own auxiliary communication port or interface to a master promotional controller 258. The promotional module receives coupon data from the master promotional controller as described herein. The machine controller 252 is also coupled to the printer 254 by a primary communication port or interface of the printer and uses an appropriate protocol for communication with the printer.

The machine controller 252 is further coupled to a SMIB 256 and communicates with the SMIB using a SAS protocol although it should be understood that other protocols may be suitable for use.

The SMIB 256 is further coupled to a network 259 through which the SMIB communicates with other devices and systems in a gaming establishment such as accounting servers, player tracking servers and the like.

In operation, the promotional module 250 receives coupon data from the master promotional controller 258. The promotional module then stores the coupon data for later use as described herein. The machine controller receives cash-in data from a bill validator or acceptor or other device (not shown) and transmits the cash-in data to the SMIB 256. At the same time, the machine controller can transmit the cash-in information to the promotional module. The SMIB then forwards the cash-in data to an accounting server or the like (not shown) via the network 259. As the machine controller executes a game for a player, the machine controller may or may not send play metrics to the SMIB and the promotional module. When the player cashes-out from the game, the machine controller transmits cash-out data to the promotional module and to the SMIB. The SMIB then retrieves cash-out information including voucher data from an accounting server or the like (not shown) in response to the cash-out data. The SMIB forwards the cash-out information to the machine controller. The machine controller then sends the voucher data to the printer 254 via the printer's primary communication port or interface for printing a voucher for the player. The machine controller may also send the voucher data to the promotional module. As the promotional module has the cash-in information, voucher information, play metrics, etc., the promotional module can use this information to determine if a coupon should be printed. If the promotional module determines that a coupon should be printed, the promotional module generates coupon data as described herein. The promotional module transmits the generated coupon data to the printer via the printer's auxiliary communication port or interface for printing a coupon for presentation to a player.

In one aspect, the promotional module 250 and the master promotional controller 258 may be directly coupled to each other through a wired connection. In another aspect, the promotional module and the master promotional controller are coupled via a network. In yet another aspect, the promotional module and the master promotional controller are coupled via a wireless connection, either directly or indirectly through a network.

FIG. 2d is a deployment diagram illustrating another aspect of using a promotional module coupled to a printer and a master promotional controller. A promotional module 230 is coupled to a master promotional controller 238. The promotional module receives coupon data from the master promotional controller as described herein. The promotional module is further coupled to a gaming machine printer 232 via the printer's auxiliary communication port or interface.

The printer 232 is further coupled to a vending or gaming machine controller 236 via a primary communication port or interface of the printer.

The machine controller 236 is further coupled to a network 239 through which the machine controller communicates with other devices and systems in a gaming establishment such as accounting servers, player tracking servers and the like.

The promotional module 230 and the machine controller 236 may communicate with the printer 232 using a communication protocol such as Universal Serial Bus (USB), RS-232, NetPlex, etc.; however, it will be understood by those skilled in the art of printer protocols that many such protocols are suitable for such a purpose.

In operation, the promotional module 230 receives coupon data from the master promotional controller 238. The promotional module then stores the coupon data for later use as described herein. The machine controller receives cash-in data from a bill validator or acceptor or other device (not shown) and transmits the cash-in data to an accounting server or the like (not shown) via the network 239. The promotional module detects the cash-in data as described herein and stores the cash-in data for further use. As the machine controller executes a game for a player, the promotional module detects the game play metrics as described herein and stores them for later use. When the player cashes-out from the game, the machine controller uses the cash-out data to retrieve cash-out information including voucher data from an accounting server or the like (not shown) in response to the cash-out data. The machine controller then sends the voucher data to the printer 232 via the printer's primary communication port or interface for printing a voucher for the player. The promotional module may or may not detect the voucher data as described herein. As the promotional module has the cash-in information, voucher information, play metrics, etc., the promotional module can use this information to determine if a coupon should be printed. If the promotional module determines that a coupon should be printed, the promotional module generates coupon data as described herein. The promotional module transmits the generated coupon data to the printer via the printer's auxiliary communication port or interface for printing a coupon for presentation to a player.

In one aspect, the promotional module 230 and the master promotional controller 238 may be directly coupled to each other through a wired connection. In another aspect, the promotional module and the master promotional controller are coupled via a network. In yet another aspect, the promotional module and the master promotional controller are coupled via a wireless connection, either directly or indirectly through a network.

In another aspect, the machine controller 236 may be coupled to the network via a SMIB.

FIG. 2e is a deployment diagram illustrating another aspect of using a promotional module coupled to a gaming or vending machine controller, a master promotional controller and a printer. A promotional module 240 is coupled to a master promotional controller 248 via an auxiliary communication port or interface. The promotional module receives coupon data from the master promotional controller via the auxiliary communication port or interface as described herein. The promotional module is further coupled to a vending or gaming machine controller 246 via the promotional module's primary communication port or interface. The promotional module is further coupled to a gaming machine printer 242 via a printer port or interface of the promotional module. The promotional module 240 may communicate with the machine controller and the printer 242 using a communication protocol such as Universal Serial Bus (USB), RS-232, NetPlex, etc.; however, it will be understood by those skilled in the art of printer protocols that many such protocols are suitable for such a purpose.

The machine controller 246 is further coupled to a network 249 through which the machine controller communicates with other devices and systems in a gaming establishment such as accounting servers, player tracking servers and the like.

In operation, the promotional module 240 receives coupon data from the master promotional controller 248 and stores the coupon data for later use as described herein. The machine controller 246 receives cash-in data from a bill validator or acceptor or other device (not shown) and transmits the cash-in data to an accounting server or the like (not shown) via the network 249. The promotional module may detect the cash-in data as described herein and store the cash-in data for further use. As the machine controller executes a game for a player, the promotional module may detect the game play metrics as described herein and stores them for later use. When the player cashes-out from the game, the machine controller uses the cash-out data to retrieve cash-out information including voucher data from an accounting server or the like (not shown) in response to the cash-out data. The machine controller then sends the voucher data to the promotional module 240 via the promotional modules primary communication port or interface. The promotional module then transmits the voucher data to the printer 242 via the printer's primary communication port or interface for printing a voucher for the player. As the promotional module has the cash-in information, voucher information, play metrics, etc., the promotional module can use this information to determine if a coupon should be printed. If the promotional module determines that a coupon should be printed, the promotional module generates coupon data as described herein. The promotional module transmits the generated coupon data to the printer via the promotional module's printer interface for printing a coupon for presentation to the player.

As can be understood from the foregoing description, the promotional module 240 receives commands and data from the machine controller 246 for the printer 242, receives commands and data from the master promotional controller 248 for the printer and also generates commands and data of its own for the printer. In one aspect, the promotional module accepts the commands and data from both the machine controller and the master promotional controller intended for the printer and buffers and intermixes them such that the printer receives the commands and data as if the printer were coupled to a single device issuing the commands and sending the data. To do so, the promotional module buffers the commands and data and determines the priority of the commands and data to send to the printer. In addition, the promotional module “spoofs” the machine controller and/or master promotional controller into perceiving that the machine controller and/or master promotional controller are communicating directly to the printer by sending appropriate acknowledgements and status messages to the machine controller and/or master promotional controller. In another aspect, the promotional module switches the promotional module's printer port or interface between the promotional module's primary communication port or interface coupled to the machine controller and the promotional modules' auxiliary communication port coupled to the master promotional controller whereby each device is essentially directly connected to the printer as needed. To do so, the promotional module monitors communications between the machine controller and the printer and switches to communicate with the printer or allow the master promotional controller to communicate with the printer when the printer is not otherwise occupied with communications with the machine controller.

In another aspect, the promotional module 240 and the master promotional controller 248 may be directly coupled to each other through a wired connection. In another aspect, the promotional module and the master promotional controller are coupled via a network. In yet another aspect, the promotional module and the master promotional controller are coupled via a wireless connection, either directly or indirectly through a network.

In another aspect, the machine controller 246 may be coupled to the network via a SMIB.

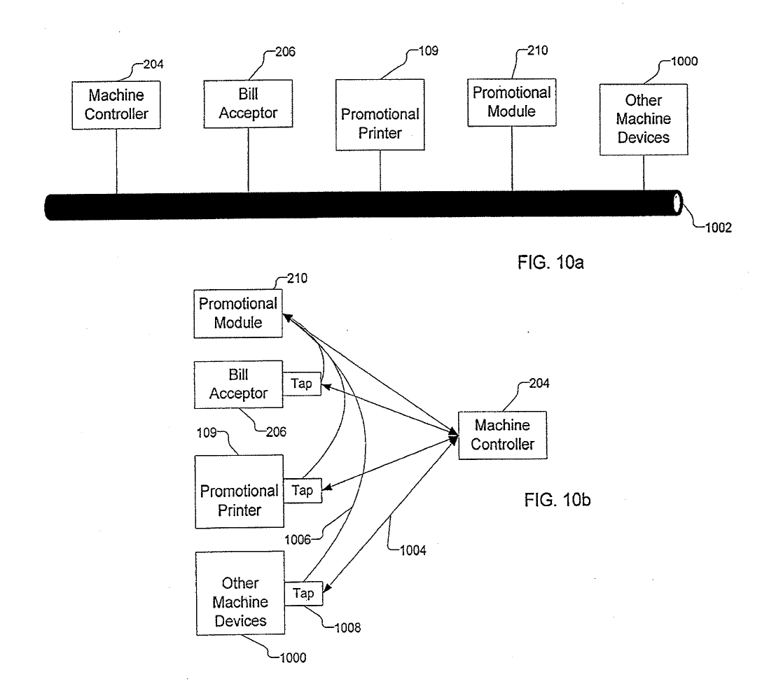

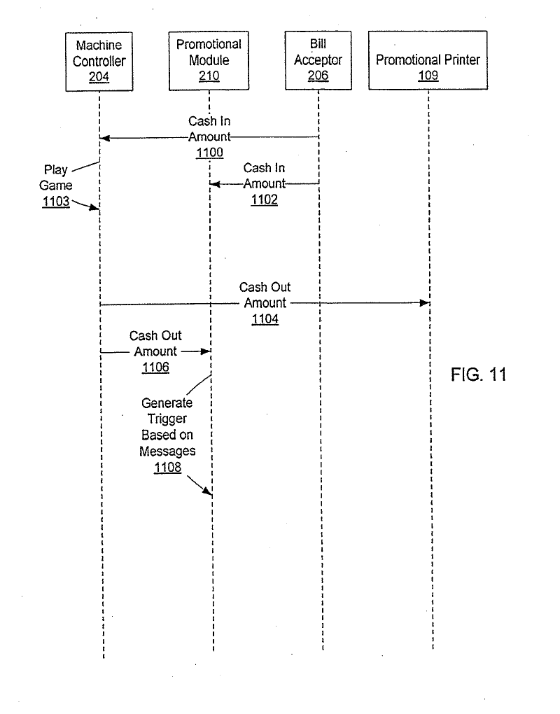

FIG. 10a is a block diagram of a gaming or vending machine incorporating a multidrop communications network in accordance with an exemplary embodiment of the present invention. A gaming or vending machine may employ a multidrop communications network 1002 to route communications between a machine controller 204 and various devices in the gaming or vending machine. In this embodiment of a gaming or vending machine, the machine controller communicates with a bill validator or acceptor 206, a promotional printer 109, a promotional module 210, and other gaming or vending machine devices 1000 over the multidrop network. In such a network, each specific device or controller has a unique address. The specific device or controller listens to all the messages sent through the network by the various controllers and devices on the network but may only respond to messages that are addressed to that specific device. As such, the promotional module may passively “listen in” on gaming or vending machine operational signals, such as messages meant for the other devices, by receiving messages intended for the other devices and not responding to any message not intended for the promotional module. In this way, the promotional module can determine the state of the gaming or vending machine as the gaming or vending machine operates by examining communications between the disparate devices.

FIG. 10b is a block diagram of a gaming or vending machine incorporating a point-to-point communications system in accordance with an exemplary embodiment of the present invention. In this embodiment of a gaming or vending machine, a machine controller 204 is coupled to the various devices, such as bill validator or acceptor 206, promotional printer 109, and other such gaming or vending machine devices 1000, incorporated into the gaming or vending machine by one or more point-to-point communications links 1004. As each device has its own communications link with the machine controller, a gaming promotional controller has no opportunity to listen in on a network communications. Instead, a promotional module 210 listens in on communications between the disparate devices by receiving one or more communications signals 1006 gleaned from one or more listening taps 1008 installed on the devices.

The taps may be passive devices that merely duplicate the signals being transmitted between the devices or controller. If the taps are passive devices, the promotional module discerns which communications are being sent by which devices. To do so, the promotional module may parse a message and determine from the contents of the message which device sent the message. The promotional module may also incorporate one or more communication ports or interfaces with each communication port or interface assigned to a specific device. The promotional module may then identify the specific device transmitting a message by simply knowing which communication port or interface received the message.

The taps may also be active devices. In this case, a tap may add a header to any messages transmitted to or from a device to which the tap is coupled, thereby associating each message with a device identifier.

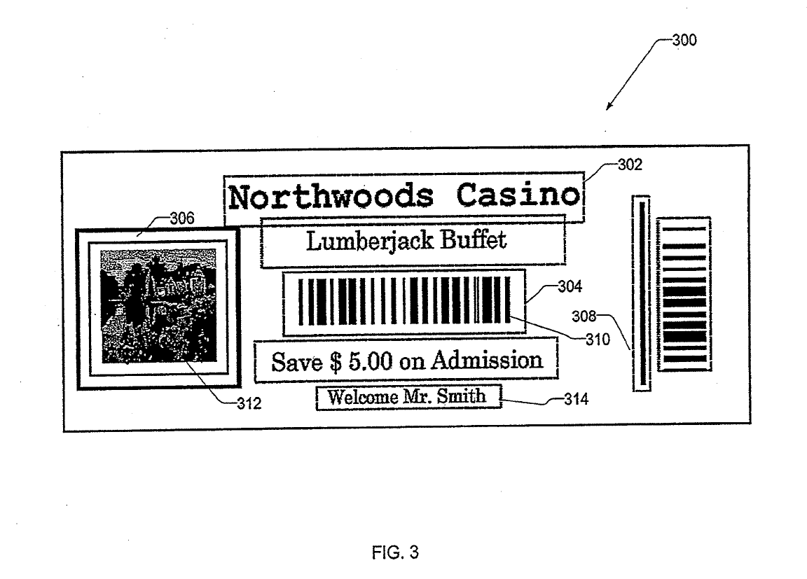

FIG. 3 is an illustration of a coupon including logical fields described in a template based printer language in accordance with an exemplary embodiment of the present invention. The template based printer language may also used to define a voucher. In this example, a coupon 300 may include four types of data fields: text fields, such as text field 302; barcode fields, such as barcode field 304; graphic fields, such as graphic field 306; and line/box draw fields, such as line/box draw field 308. The fields of a coupon are described using coupon description data included in an electronic template that may be stored by a promotional printer. A template may include a plurality of fields in combination, resulting in a paste up style printed coupon. A plurality of templates describing different types of coupons may be stored in a promotional printer supporting a rich couponing environment.

The actual value or data for each of the fields described in a coupon template may or may not be included in the template itself For example, a template may include a barcode field for printing a barcode 310. However, the actual value of the barcode is transmitted to a promotional printer at the time a coupon is generated using the coupon template. In this way, a coupon may have fields that include static data, such as graphic 312 in a graphic field, or dynamic data, such as the name of a particular patron 314 in a text field. In this way, customized coupons may be printed by a promotional printer without transferring large amounts of data through a communications network coupling a promotional printer to a master promotional controller.

In addition, data that is used to track usage of coupons may be included in a coupon. For example, a barcode field or a text field may be used to print a barcode value or text string uniquely identifying a coupon. In this way, a gaming provisional printer creates an image of a barcode or barcodes, characters or marks that may be read by a cashless enabled gaming or vending machine bill validator or acceptor on the same or another cashless enabled gaming or vending machine, allowing automatic acceptance of coupons into a cashless enabled gaming system in a casino or another related casino property.

A coupon template includes a plurality of command strings. Each command string conforms to the following syntax:

delimiter<cmd_Ltr>|<data_field1>| . . . |<data_fieldx>|delimeter; comment

where:
delimiter=a delimiter character
<cmd_ltr>=command identifier letter
<data_fields1-x>=fields which include information relative to the command
   |=Pipe character. This serves as the delimiter between data fields in a command.
; =Semi-colon. This is a comment field designator.

A template defining a coupon adheres to following syntax:
delimiter<template_cmd_ltr>|<t_{‘3}id>|<targ_mem>|<t_dim_da>|<t_dim_pa>|<pr#1>|<pr#2>| . . . |<pr#n>|delimiter
   where:
   <t_id>=Template I.D.
   <targ_mem>=target memory storage.
   <t_dim_da>=Template dimension on a dotline axis in dots.
   <t_dim_pa>=Template dimension in dots in the paper axis.
      <pr#1> . . . <pr#n>=list of coupon database resident print regions ID's used in the format of this coupon. These fields are the method by which print regions used on a coupon are linked together and to the coupon template.

A print region is a print field used in a template to format print data. The print region command is used to define the basic types of print regions such as text, barcode, graphics, and a line/box draw.

A define print region command defines the particular font, barcode, graphic, or line style which is to be used, and provides special formatting information on how it is to be used. Multiple print regions may be defined and memorized in a promotional printer's coupon database.

A define print region command adheres to the follow syntax:
delimiter<print_region_cmd_ltr>|<r_id>|<targ_mem>|<da_start>|<pa_start>|<da_len>|<pa_len>|<rot>|<just>|<obj_id>|<mul_1>|<mul_2>|<obj_att>|<pr_att>|<pr_data>|delimter
   where:
   <r_id>=print region identifier.
   <targ_mem>=target memory storage.
   <da_start>=dot axis start position in dots.
   <pa_start>=paper axis start position in dots.
   <da_len>=dot axis length of print region in dots.
   <pa_len>=paper axis length of print region in dots.
   <rot>=rotation of strings or data within print region.
   <just>=justification of data within print region.
   <obj_id>=print object identifier. Range 1 byte. This is the print object (barcode, font, line/box or graphic) used to format print the data from a print command.
   <mul_1>=Print object multiplier 1. For text, it is a font width multiplier. For barcodes, it indicates narrow bar width or modulo bar width. For a line, this represents thickness of the line in dots.
   <mul_2>=Print object multiplier 2. For text, this represents a font height multiplier. For a barcode, it indicates a wide bar width.
   <obj_att>=object printing attributes. This contains special instructions on how to treat the print objects within a print region
   <pr_att>=print region attributes. This contains special instructions on handling of the print region. A >0′ indicates text will be sent in a print batch command. A ‘1’ indicates use text which follows in pr_data field for a print region. A ‘2’ indicates a print region will auto increment with each coupon in a batch. The base value is stored in a pr_data field. A ‘3’ indicates an auto-decrement print region which will auto-decrement with each coupon in a batch. The base value is stored in a pr_data field.

<pr_data>=permanently stored data which always appears in this print region. This field contains stored text if requested by entering a >2′ in <pr_att>field.

A library command is used to manage defined graphics. A library command adheres to the following syntax:
delimiter<library_cmd_ltr>|<lib_funct>|<mem>|<obj_id>|<mem_req>|<ld_file_size>|obj_data_delimiter where:
   <lib_funct>=operation to perform: ‘A’—add object, enter download mode, ‘D’—delete object.
   <mem>=target memory in which to place the object being downloaded.
   <obj_id>=object identification. This is the object I.D. byte.
   <mem_req>=memory usage specifier. For loading a graphic: size of a graphic file. The library command header is terminated after this field and obj_data is expected immediately following. For deleting graphics: ‘G’ is used in this field.
   <ld_file_size>=file size indicator.
   obj_data=object data (font or graphic) in appropriate format if <lib_funct>=‘A’. Format for graphics: PCX.

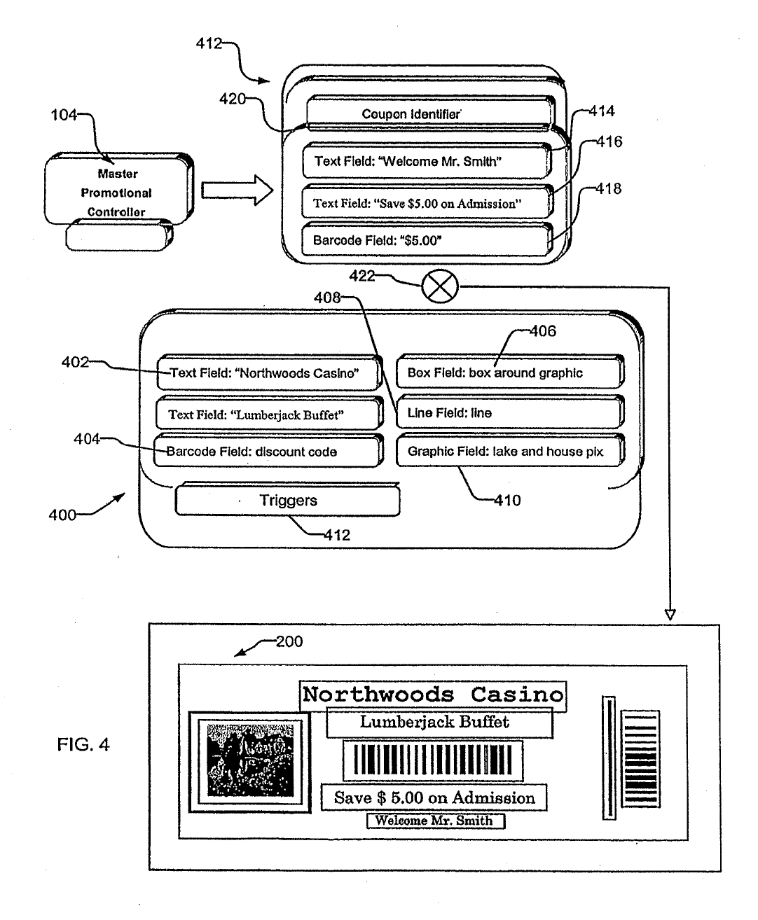

FIG. 4 is a block diagram of coupon template field element stored partially resident in a promotional gaming printer and partially supplied by a master promotional controller at the time of print and issuance in accordance with an exemplary embodiment of the present invention. FIG. 4 illustrates how a master promotional controller selects a type of coupon and transmits particulars, such as variable data to be placed in fields in the coupon, for each print and issuance event. Values for the fields that make up a coupon 300 may be divided into two groups or sets. A resident variable data set 400 may be stored locally in a promotional printer. The resident set of variable data may include variable data such as: variable data for a text field containing an identifier of a casino 402; variable data for a barcode field identifying a type of promotion 404; a template description used to generate a graphic such as box variable data 406 or line variable data 408; or an identifier or actual variable data for a graphic 410. A dynamic variable data set include variable data for fields having variable data that are stored in the promotional printer and are saved in a template definition for a particular coupon. Examples of variable data in a dynamic variable data set include: text variable data for a player identifier 414; text variable data describing a promotion item 416; and barcode variable data 418 for quantifying a value of a promotion for printing on the coupon.

Both variable data sets may be transmitted from a master promotional controller 104 to a promotional printer in the form of communication packets. When a promotional printer receives a variable data set, the promotional printer stores the variable data set for future use. A resident variable data set includes variable data that may be reused for generating many coupons; therefore, a resident variable data set may be stored in he promotional printer for an extended period of time. In contrast, a dynamic variable data set may be used for a short period of time, perhaps for even a single generation of a single coupon. As such, the dynamic variable data set and static variable data set associated in a coupon may be transmitted to a promotional printer at different times. To retain association between the variable data sets, part of the communication packet issued by the master promotional controller may include a reference 420 to a template definition so that the dynamic data in the communication packet can be combined 422 with the static field data stored in a promotional printer to generate a complete coupon 200.

Since it is possible to store all fields used in a coupon within the promotional printer's memory, a master promotional controller may issue a complete coupon by simply sending a reference to a coupon so defined to generate a coupon in its entirety. It is also possible for a master promotional controller to offload the entire live communication burden by sending a complete coupon database including triggers during off peak times.

In one embodiment of a promotional printer, a promotional printer is triggered to print coupons from the promotional printer's internal database under direct control of a master promotional controller that triggers the issuance of a coupon and conveys any pertinent variable information associated with the coupon such as promotion type, face value of the coupon, date of expiration and the like.

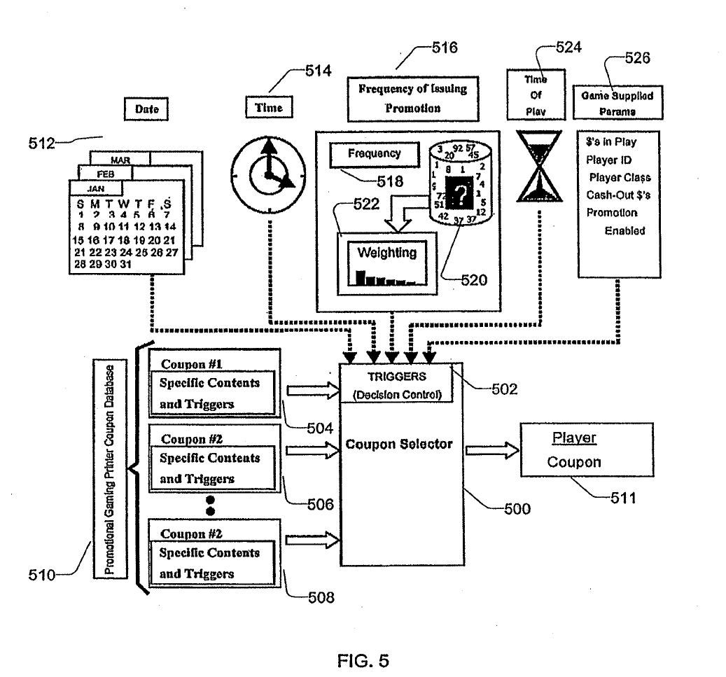

FIG. 5 is a block diagram of an exemplary coupon stack and logical trigger matrix resident in a promotional printer in accordance with an exemplary embodiment of the present invention. As previously noted, a promotional printer may print a coupon in response to either internal or external event signals or trigger data. To respond to a trigger, a promotional printer includes a coupon selector logic module 500 that analyzes trigger data 502 as trigger data becomes available and determines which coupons should be printed in response to the trigger data. Coupons, such as coupons 504, 506, and 508, are stored in a coupon database 510 as a stack. The stack of coupons are a plurality of predefined coupons that can generate a coupon 511 anytime a set of trigger conditions to which a coupon is associated is satisfied. These trigger conditions can operate independently or in logical combination.

Exemplary logical trigger data utilized in a promotional printer for initiating generation of coupons includes: date 512, time of day 514, frequency of issuance of a particular coupon 516, time of play 524, and game issued parameters 526 to the printer such as player identification, amount of money in place, duration of the current session of play and the like. By utilizing the illustrated trigger matrix, it is possible for a promotional printer to issue coupons without any information provided by a master promotional controller at the time of a cash out or cash in by a player.

In one promotional printer in accordance with an exemplary embodiment of the invention, the promotional printer receives from a master promotional controller a coupon trigger database thereby enabling the promotional printer to self manage its couponing activity. The coupon trigger database may include different types of trigger control parameters including: triggering a coupon generation anytime a cash out voucher is printed; generating a coupon whenever a voucher for greater than, equal to, or less than a specified amount of money is issued; generating a coupon based on an identity of a player; generating a coupon based on a category or classification of a player related to frequency of play or money volume; generating a coupon based on the duration of play of the gaming machine by a player; and generating a coupon anytime a player adds money or credits to a game in an amount greater than, equal to, or less than a specified amount.

In another aspect of the invention, a component of the promotional printer's internal database includes a set of control parameters that instruct the promotional printer to select the type, quantity, and frequency of coupons to create and issue related to any of the triggers listed above. These control parameters may operate separately or in combination with each coupon in the database. Parameters that may be used include: a total quantity of a coupon being issued before the coupon is retired from the coupon database; a frequency 518 of issuance of a coupon based on the number of occurrences of specified trigger events; a frequency of issuance of a coupon based on random odds 520, such as one in one hundred trigger events; a backup coupon or coupons should a particular coupon fail to print for lack of satisfying its specified set of qualifiers; whether or not the coupon is issued based on the time the trigger occurred; and whether the coupon is issued based on the date the trigger occurred.

In one embodiment of promotional printer, a real time clock electronic device is included within the promotional printer for the purposes of supporting time dependent promotional activity as described above.

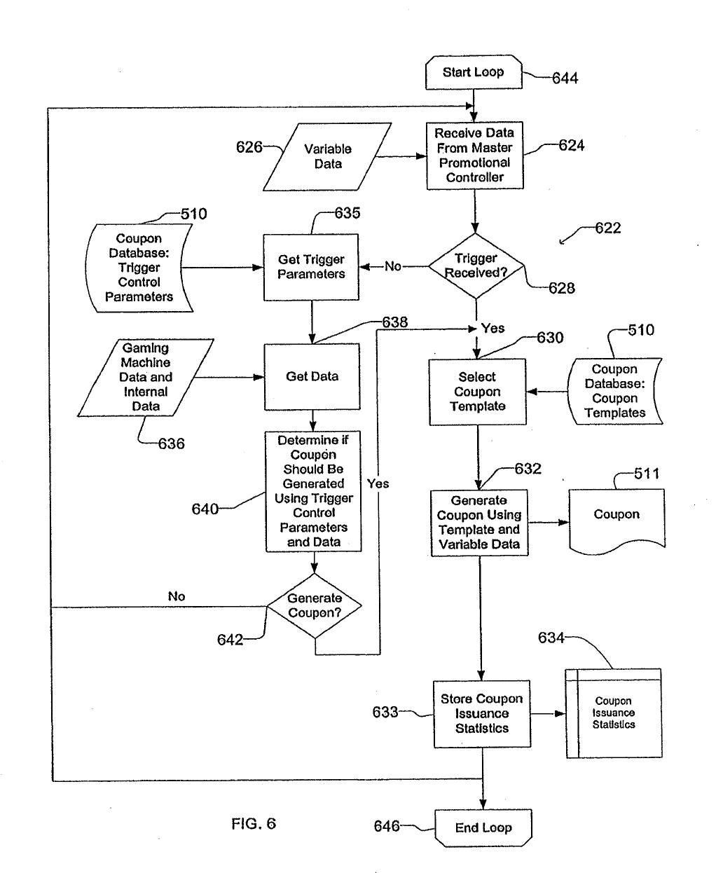

FIG. 6 is a process flow diagram of a trigger matrix process in accordance with ane exemplary embodiment of the present invention. A trigger matrix process 622 is used by a promotional printer to determine if a coupon should be generated and issued to a player. The trigger matrix process receives (624) variable data from a master promotional controller. The trigger matrix process determines (628) if the variable data includes a coupon trigger instructing the promotional printer to issue a coupon. If so, the trigger matrix process selects (630) an appropriate coupon to issue from a coupon database 510. The trigger matrix process then generates (632) a coupon 511 using the selected coupon template. In addition, the trigger matrix process may use a portion of the variable data received from the master promotional controller to customize the coupon when the coupon is generated. The trigger matrix process may then store (633) coupon issuance statistical data (634) for later retrieval by the master promotional controller.

A trigger matrix process may also initiate issuance of a coupon even if the master promotional controller does not transmit a trigger to the promotional printer. To do so, the matrix trigger process gets (635) trigger control parameters stored in the promotional coupon database 510 that correspond to stored coupon templates in the promotional coupon database. The trigger matrix process then gets (638) gaming or vending machine and other internal data 636 and determines (640) if a coupon should be issued using the data and trigger control parameters. If the trigger matrix process determines (642) that a coupon should be generated, the trigger matrix process issues a coupon as previously described, this time selecting a coupon template using the trigger control parameters.

The promotional printer is a real-time device meaning that it continuously processes incoming trigger data and triggers. As such, the trigger matrix process may be configured as an endless loop as indicated by the start loop 644 and stop loop 646 symbols.

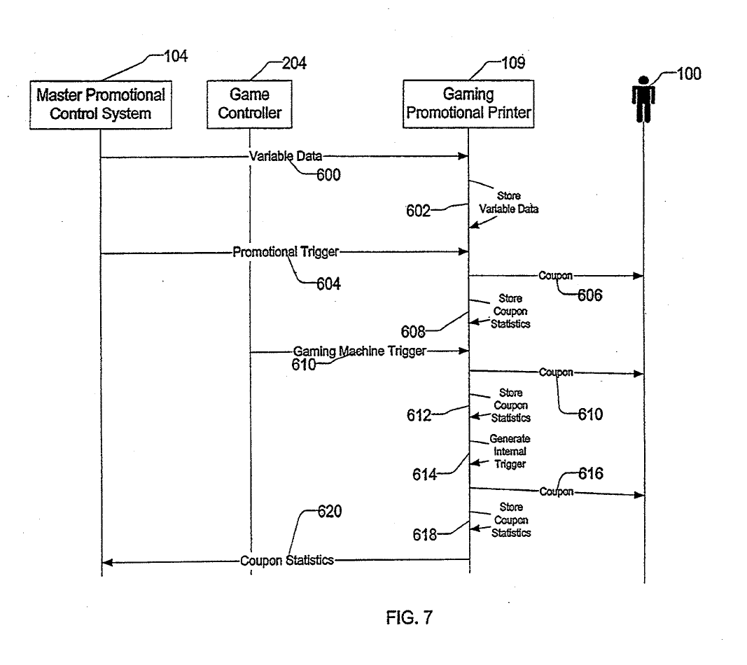

FIG. 7 is a sequence diagram of a coupon generating process in accordance with an exemplary embodiment of the present invention. A master promotional controller 104 transmits coupon or variable data 600 to a promotional printer 109. The promotional printer stores (602) the coupon data for later use by the promotional printer in printing a coupon. As previously described, the coupon data may include coupon templates, sets of dynamic and static variable data, trigger control parameters, and entire promotional coupon databases.

A promotional printer may receive various triggers that initiate generation of a coupon for a player 100. The master promotional controller may transmit a promotional trigger (604) to the promotional printer. In response to the promotional trigger, the promotional printer generates a coupon 606 for use by the player. The promotional printer then stores (608) statistical data about the just generated coupon. The promotional printer may also receive a gaming or vending machine trigger 610 from a machine controller 204 in a cashless enabled gaming or vending machine. In response to the gaming or vending machine trigger, the promotional printer generates a coupon 610 for use by the player. The promotional printer then stores (612) statistical data about the just generated coupon. The promotional printer may also generate (614) an internal trigger on its own such that the promotional printer generates a coupon 616 for use by the player. The promotional printer then stores (618) statistical data about the just generated coupon.

Periodically, or at the request of the master promotional controller, the promotional printer may transmit the saved coupon statistical data to the master promotional controller for analysis and other types of processing. The coupon tracking or statistical data may include details such as quantities of specific types of triggers received, quantities of each type of coupon issued, and the times and dates when triggers were received and coupons were issued.

FIG. 11 is a sequence diagram of a promotional module using passive listening to generate coupon triggers. In this embodiment, a promotional module 210, either as a standalone device or coupled to a printer to form a promotional printer, listens in on communications between a machine controller 204 and a other devices, such as bill validator or acceptor 206 and promotional printer 109. The promotional module listens in on the communications and generates coupon triggers based on various attributes of the messages, such as frequency of the messages, content of the messages, originator of the messages, receiver of the messages, etc. Once the trigger is generated, it is used as previously described by the gaming or vending machine to generate a coupon.

In a specific example of such a process, the bill validator or acceptor receives a voucher, currency, or other value bearing token from a player and transmits a cash-in amount 1100 to the machine controller. The promotional module listens in on the communication between the bill validator or acceptor and the machine controller and receives an identical cash in amount 1102 message or signal. In response to the cash-in amount, the machine controller allows the player to play (1103) the gaming machine. Eventually, the player will stop playing the game and request a cash-out. In response, the machine controller transmits a cash-out amount 1104 to the promotional printer. The promotional module receives a copy of the cash-out signal or message 1106. The promotional module may then generate (1108) a trigger based on the cash-in and cash-out messages that the promotional module listened in on but did not respond to.

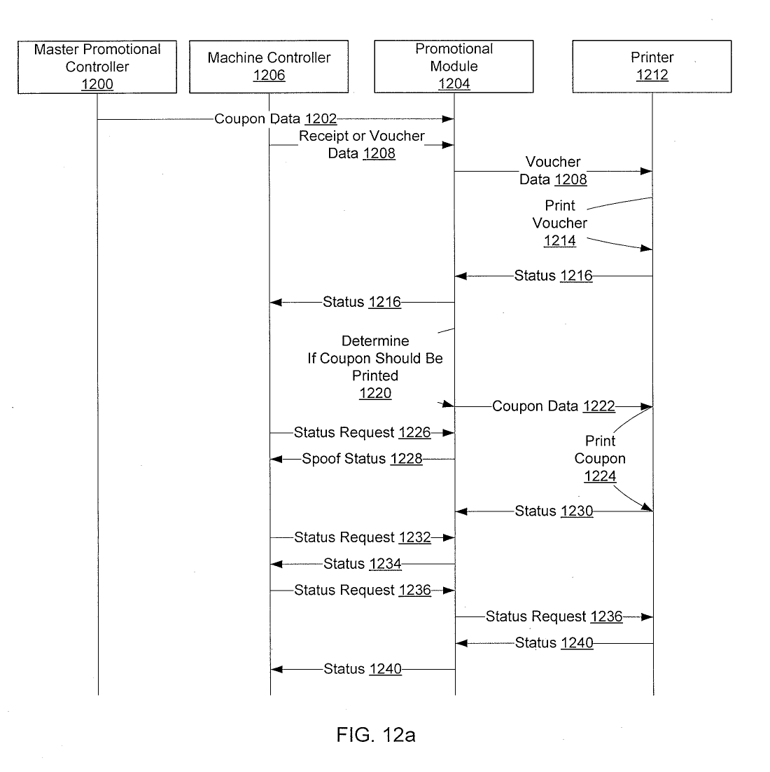

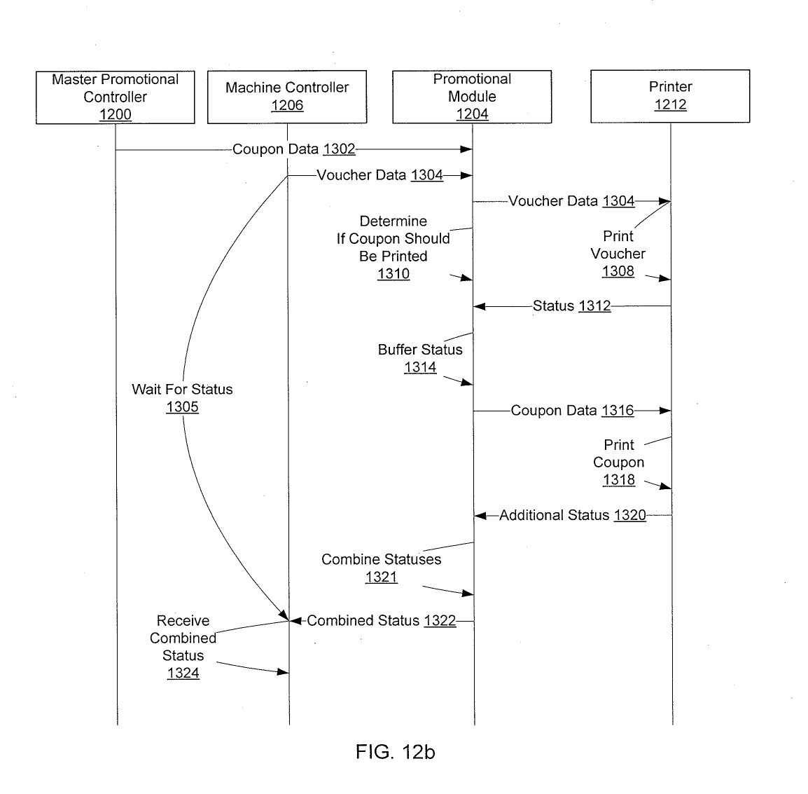

FIG. 12a is a sequence diagram of an aspect of couponing and vouchering operations in a system having a promotional module coup led to a printer, a gaming or vending machine controller and a master promotional controller. A master promotional controller 1200 transmits coupon data 1202 to a promotional module 1204 via the promotional module's auxiliary communication port or interface and the promotional module stores the coupon data for future use. A vending or gaming machine controller 1206 transmits voucher data 1208 to the promotional module via the promotional module's primary communication port or interface for printing of a voucher. The promotional module receives the voucher data and forwards the voucher data to a gaming machine printer 1212 for printing (1214) of the voucher. When completed, the printer sends status data 1216 to the promotional module. The promotional module forwards the status data to the machine controller so that the machine controller can determine if the voucher was printed.

The promotional module then determines (1220) whether or not a coupon should be printed based on associated play metrics and trigger data using any of the processes described herein. If the promotional module determines that a coupon should be printed, the promotional module sends coupon data 1222 to the printer. The printer then uses the coupon data to print (1224) a coupon. If the machine controller sends a printer status request 1226 to the promotional module requesting the status of the printer, the promotional module spoofs the machine controller by sending spoof status data 1228 to the machine controller. The spoof status data imitates status data that the printer would have normally sent to the machine controller indicating that the printer was busy, free or otherwise operational.

When the printer 1212 is finished printing the coupon, the printer sends actual status data 1230 to the promotional module and the promotional module stores the status data. When the machine controller again sends a printer status request 1232 to the promotional module, the promotional module sends the stored status data 1234 to the machine controller.

When the printer is idle and the promotional module 1204 receives a printer status request 1236 from the machine controller 1206, the promotional module forwards the status request directly to the printer 1212. The printer then responds by sending status data 1240 to the promotional module. The promotional module then sends the status data 1240 to the machine controller.

FIG. 12b is a sequence diagram of another aspect of couponing and vouchering operations in a system having a promotional module coupled to a printer, a gaming or vending machine controller and a master promotional controller. A master promotional controller 1200 sends coupon data 1302 to a promotional module 1204. The promotional module stores the coupon data until the coupon data is used to print a coupon.

A vending or gaming machine controller 1206 sends voucher data 1304 to the promotional module. In addition, the machine controller waits (1305) for a return status from a gaming machine printer 1212 that the voucher data was intended for. The promotional module forwards the voucher data to the printer. The printer prints (1308) a voucher using the voucher data. The promotional module determines (1310) whether or not a coupon should be printed based on associated play metrics and trigger data using any of the processes described herein. When the printer completes printing of the voucher, the printer sends status data 1312, intended for the machine controller, to the promotional module. The promotional module buffers (1314) the status data by storing it in a temporary data store.

If the promotional module determines that a coupon is to be printed, the promotional module sends coupon data 1316 to the printer. The printer uses the coupon data to print (1318) a coupon and sends additional status data 1320 to the promotional module indicating that the coupon has been printed. The promotional module receives the additional status data and combines (1321) the additional status data with the status data received after the voucher was printed. The promotional module then sends the combined status data 1322 to the machine controller 1206 waiting (1305) for a response to sending the voucher data 1304. The machine controller then receives (1324) the combined statuses.

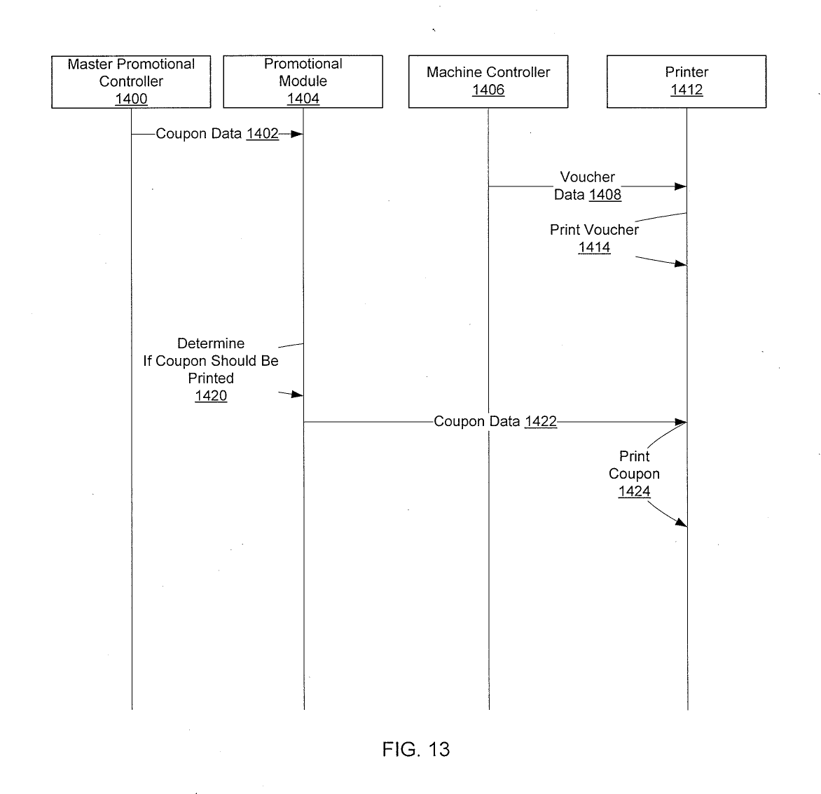

FIG. 13 is a sequence diagram of a process of couponing and vouchering operations in a system having a promotional module coupled to a gaming machine printer, a gaming machine controller, and a master promotional controller in accordance with an exemplary embodiment. A master promotional controller 1400 sends coupon data to a promotional module 1404 and the promotional module stores the coupon data for later use. When a player plays a gaming machine controlled by gaming machine controller 1406, the promotional module detects gaming metrics of the player's play as described herein. In response to a cash-out signal by the player, the machine controller 1406 sends voucher data to a gaming machine printer 1412 via the printer's primary communication port or interface. The printer uses the voucher data to print (1414) a voucher for presentation to the player.

Using the play metrics and associated trigger data, the promotional module 1404 determines (1420) if a coupon should be printed for the player using any of the processes described herein. If the promotional module determines that a coupon should be printed, the promotional module sends coupon data 1422 to the printer using the printer's auxiliary communication port or interface. The printer uses the coupon data to print (1424) a coupon for present at ion to the player.

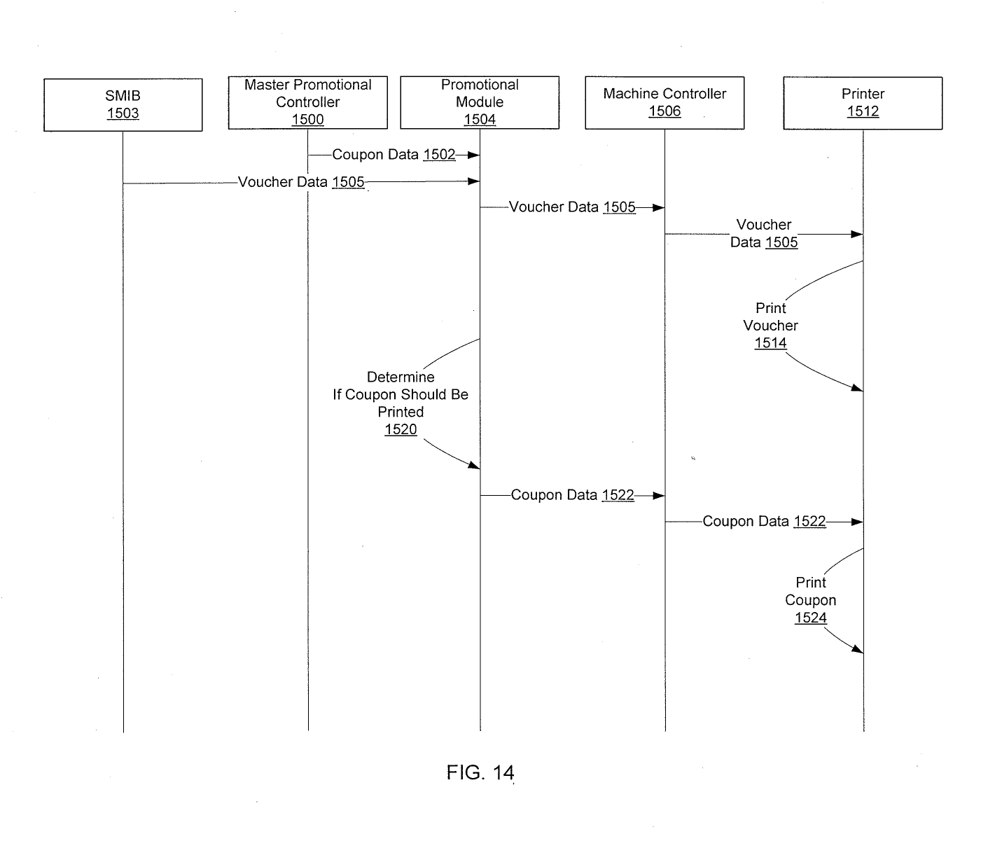

FIG. 14 is a sequence diagram of another process of couponing and vouchering operations in a system having a promotional module coupled to Slot Machine Interface Board (SMIB) a gaming machine printer, a gaming machine controller and a master promotional controller in accordance with an exemplary embodiment. A master promotional controller 1500 sends coupon data 1502 to a promotional module 1504 via the promotional modules auxiliary communication port or interface. The promotional module stores the coupon data for later use. During play by a player of a gaming machine controlled by a gaming machine controller 1506, the promotional module detects player metrics associated with trigger data as described herein. When it is time to cash-out the player, and in response to a cash-out request (not shown) sent from the machine controller to the SMIB via the promotional module, the SMIB sends voucher data 1505 to the promotional module via the promotional module's primary communication port or interface. The promotional module forwards the voucher data to the machine controller and the machine controller sends the voucher data to a gaming machine printer 1512 via the printer's primary communication port or interface. The printer uses the voucher data to print (1514) a voucher. The promotional module uses the play metrics associated with trigger data and the voucher data to determine (1520) if a coupon should be printed using any of the processes described herein. If it is determined that coupon should be printed, the promotional module generates coupon data 1522 and sends the coupon data to the machine controller. The machine controls then sends the coupon data to the printer. The printer uses the coupon to print (1524) a coupon for presentation to the player.

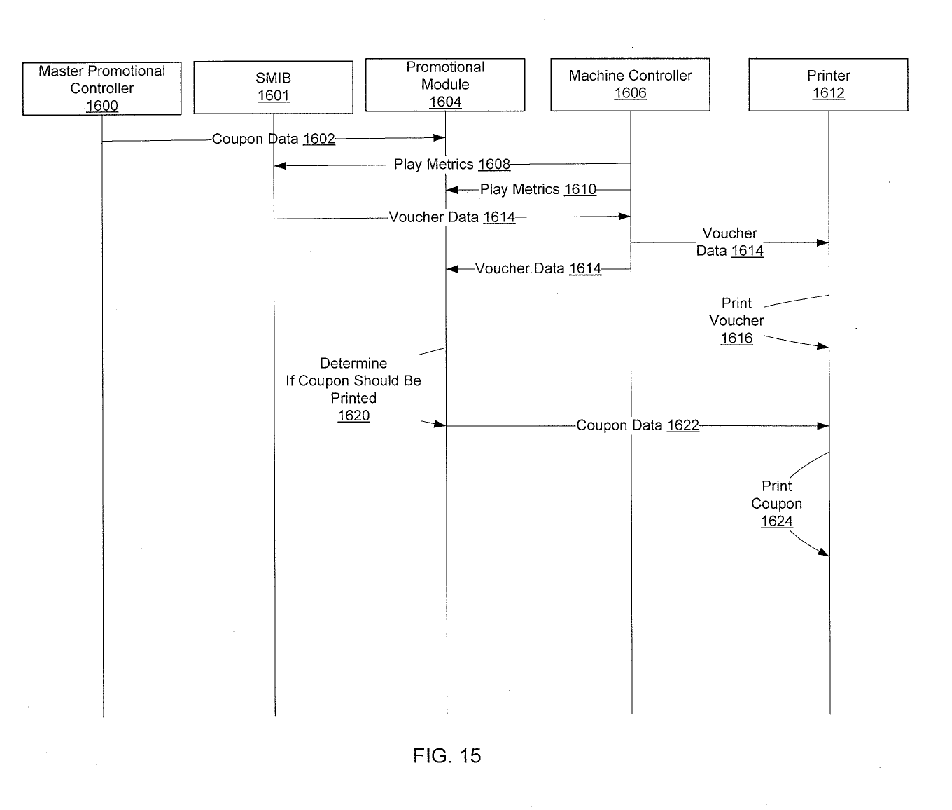

FIG. 15 is a sequence diagram of another process of couponing and vouchering operations in a system having a promotional module coupled to Slot Machine Interface Board (SMIB), a printer, a gaming or vending machine controller and a master promotional controller in accordance with an exemplary embodiment. A master promotional controller 1600 sends coupon data 1602 to a promotional module 1604. The promotional module stores the coupon data for later use. During play by a player of a gaming machine controlled by a gaming machine controller 1606, the machine controller sends play metrics 1608 to a SMIB 1601. The machine controller also sends play metrics 1610 to the promotional module. The promotional module may also detect additional play metrics as described herein.

When it is time to cash-out the player, and in response to a cash-out request (not shown) sent from the machine controller 1606 to the SMIB 1601, the SMIB sends voucher data 1505 to the machine controller. The machine controller may also send the voucher data 1614 to the promotional module 1604. The machine controller sends the voucher data 1614 to a gaming machine printer 1612 using the printer's primary communication port or interface. The printer uses the voucher data to print (1616) a voucher. The promotional module uses the play metrics associated with trigger data to determine (1620) if a coupon should be printed using any of the processes described herein. If the promotional module determines that a coupon should be printed, the promotional module generates coupon data 1622 and sends it to the printer via the printer's auxiliary communication port or interface. The printer uses the coupon data to print (1624) the coupon for present at ion to the player.

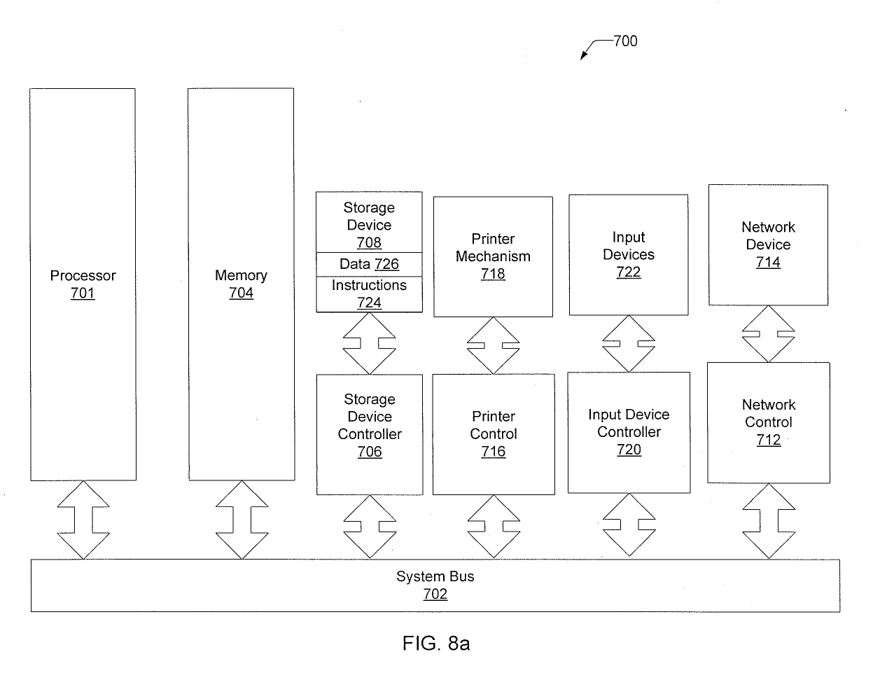

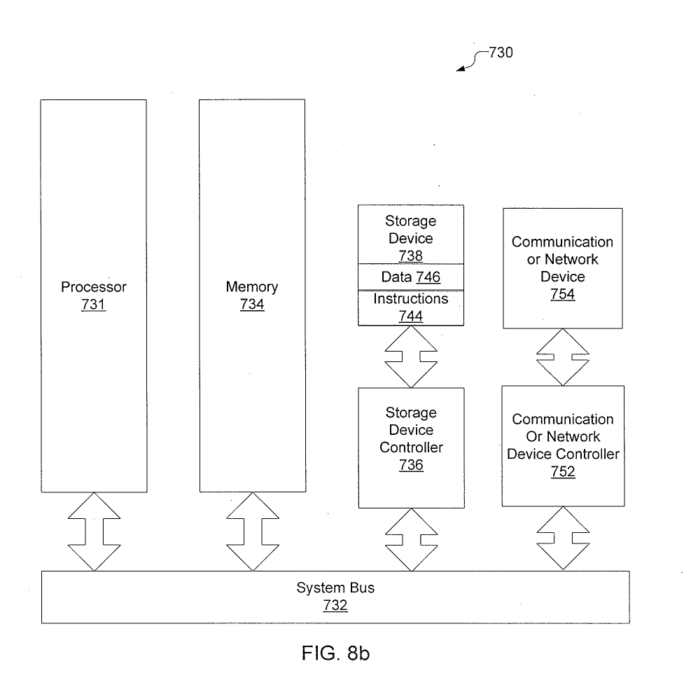

FIG. 8a is an architecture diagram of a gaming machine printer or a promotional printer in accordance with an exemplar embodiment. A gaming machine printer or a promotional printer 700 includes a processor 701 operatively coupled via a bus 702 to a main memory 704. The processor is also coupled to a storage device 708 via a storage controller 706 and the bus. The storage device includes stored program instructions 724 and data 726 such as voucher and coupon variable data, voucher and coupon templates, and coupon trigger control parameters. In operation, the program instructions implementing the features of a gaming machine printer or a promotional printer are stored on the storage device until the processor retrieves the program instructions and stores them in the main memory. The processor then executes the computer program instructions stored in the main memory and operates on the data stored in the storage device to implement the features of a gaming machine printer or promotional printer as described herein.

The processor is further coupled to a printer mechanism 718 through a printer controller 702 via the bus. In operation, the processor executes the program instructions to generate printer mechanism control signals and transmits these signals to the printer mechanism via the bus and printer controller. In response to the printer mechanism control signals, the printer mechanism prints coupons and vouchers for use by a player as described above.

The processor may be further coupled to external input devices 722 by an input device controller 720 via the bus. Example input devices include sensors that the promotional printer uses to detect proper printing of a coupon by the printer mechanism, coupon printer paper detectors, and real time clocks. The processor receives input device signals from the input devices via the input device controller and the processor and uses the input device signals to detect the state of the promotional printer's environment.

The processor is further coupled to one or more communication or network devices 714 via a communication or network device controller 712 and the bus. The processor uses the one or more communication or network devices as a communication port or interface to communicate with one or more other devices and systems, such as a master promotional controller, a promotional module or a gaming or vending machine controller as described herein.

FIG. 8b is an architecture diagram of a promotional module in accordance with an exemplary embodiment. A promotional module 730 includes a processor 731 operatively coupled via a bus 732 to a main memory 734. The processor is also coupled to a storage device 738 via a storage controller 736 and the bus. The storage device includes stored program instructions 744 and data 746 such as coupon variable data, coupon templates, and coupon trigger control parameters. In operation, the program instructions implementing a promotional module are stored on the storage device until the processor retrieves the program instructions and stores them in the main memory. The processor then executes the computer program instructions stored in the main memory and operates on the data stored in the storage device to implement the features of a promotional module as described herein.

The processor is further coupled to one or more communication or network devices 754 via a communications or network device controller 752 and the bus. The processor uses the one or more communication or network devices as communication ports or interfaces to communicate with one or more other devices or systems, such as a master promotional controller, a printer or a gaming or vending machine controller as described herein.

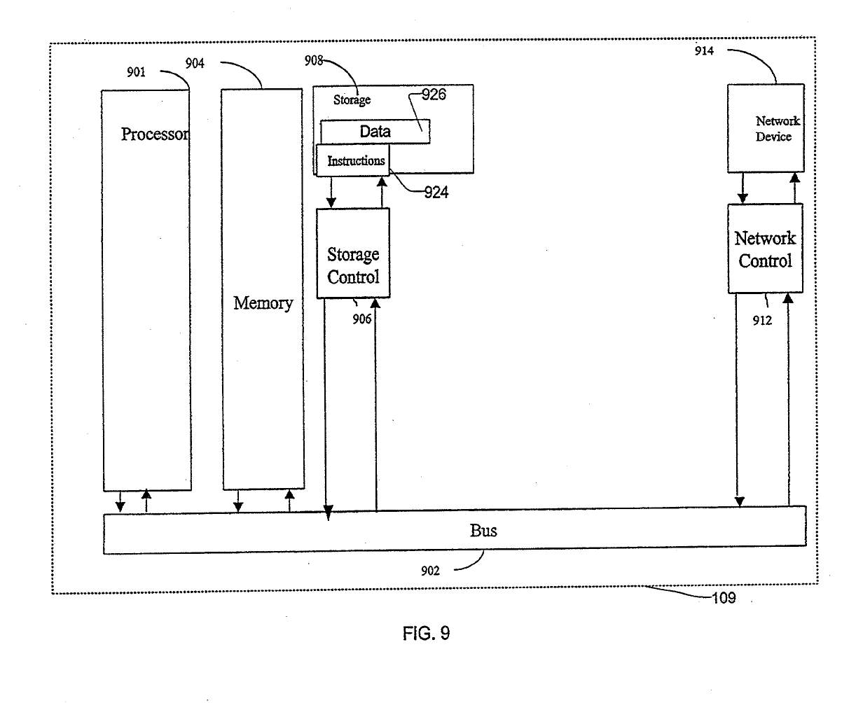

FIG. 9 is an architecture diagram of an exemplary master promotional controller in accordance with an exemplary embodiment. A master promotional controller includes a processor 901 operatively coupled via a system bus 902 to a main memory 904. The processor is also coupled to a storage device 908 via a storage controller 906 and the bus. In operation, program instructions 924 implementing a master promotional controller are stored on the storage device until the processor retrieves the program instructions and stores them in the main memory. The processor then executes the computer program instructions stored in the main memory to implement the features of a master promotional controller as described above.

The processor is further coupled to a network device 914 via a network device controller 912 and the bus. The process uses the network device as a communication port or interface to communicate with other processing systems, such as a promotional module, a promotional printer or a vending or gaming machine controller as described herein.

Although various aspects of the present invention have been described using the exemplary embodiments described herein, additional modifications and variations would be apparent to those skilled in the art. It is therefore to be understood that the present invention may be practiced otherwise than as specifically described. Thus, the exemplary embodiments described herein should be considered in all respects as illustrative and not restrictive, the scope of the invention to be determined by any claims supported by this application and the claims' equivalents rather than the foregoing description.

What is claimed is:

1. A method of printing a promotional coupon by a gaming machine, comprising:
receiving by a promotional module a first operational signal transmitted from a first device housed in the gaming machine, the first operational signal intended for a second device housed in the gaming machine, wherein the second device is not the promotional module;
generating, by the promotional module using the first operational signal, promotional coupon printing information; and
receiving by a gaming machine printer on an auxiliary communication port, the promotional coupon printing information, the gaming machine printer having a primary communication port coupled to a gaming machine controller for receiving voucher information.

2. The method of claim 1, wherein:
the second device is the gaming machine controller;
the first device is a bill validator; and
the first operational signal is a cash-in signal from the bill validator.

3. The method of claim 1, wherein:
the second device is the gaming machine printer;
the first device is the gaming machine controller; and
the first operational signal is a cash-out signal intended for reception at the primary communication port of the gaming machine printer.

4. The method of claim 1, further comprising
receiving by the promotional module a second operational signal intended for a third device housed in the gaming machine, wherein generation of the coupon printing information further comprises using the second operational signal.

5. The method of claim 4, wherein:
the second device is the gaming machine controller;
the third device is the promotional printer;
the first operational signal is a cash-in signal from a bill validator; and
the second operational signal is a cash-out signal intended for reception at the primary communication port of the promotional printer.

6. The method of claim 1, wherein the first operational signal is received by the first device from a communications network coupled to both the first device and the second device.

7. The method of claim 1, further comprising receiving coupon data by the promotional module from a promotional controller via a network, wherein generating the promotional coupon printing information by the promotional module further comprises using the coupon data.

8. The method of claim 38, wherein the coupon data includes a trigger control parameter, and wherein generating by the promotional module the promotional coupon printing information further comprises using the trigger control parameter.

9. A promotional module comprising:
a processor and a memory coupled to the processor, the memory having program instructions executable by the processor stored therein, the program instructions comprising:
receiving by the promotional module a first operational signal transmitted from a first device housed in a gaming machine, the first operational signal intended for a second device housed in the gaming machine, wherein the second device is not the promotional module;
generating, by the promotional module using the first operational signal, promotional coupon printing information; and
transmitting by the promotional module to a gaming machine printer, on an auxiliary communication port of the gaming machine printer, the promotional coupon printing information, the gaming machine printer having a primary communication port coupled to a gaming machine controller for receiving voucher information.

10. The promotional module of claim 9, wherein:
the second device is the gaming machine controller;
the first device is a bill validator; and
the first operational signal is a cash-in signal from the bill validator.

11. The promotional module of claim 9, wherein:
the second device is the gaming machine printer;
the first device is the gaming machine controller; and
the first operational signal is a cash-out signal intended for reception at the primary communication port of the gaming machine printer.

12. The promotional module of claim 9, the program instructions further comprising:
receiving by the promotional module a second operational signal intended for a third device housed in the gaming machine; and
using the second operational signal along with the first operational signal to generate the coupon printing information.

13. The promotional module of claim 9, wherein:
the second device is the gaming machine controller;
the third device is the gaming machine printer;
the first operational signal is a cash-in signal from a bill validator; and
the second operational signal is a cash-out signal intended for reception at the primary communication port of the gaming machine printer.

14. The promotional module of claim 13, wherein the first operational signal is received from a communications network coupled to both the promotional module and the second device.

15. The promotional module of claim 9, the program instructions further comprising receiving coupon data by the promotional module from a promotional controller via a network, wherein generating by the promotional module the promotional coupon printing information further comprises using the coupon data.

16. The promotional module of claim 9, wherein the coupon data includes a trigger control parameter, and wherein generating by the promotional module the promotional coupon printing information further comprises using the trigger control parameter.
